(19) United States
(12) Patent Application Publication
(10) Pub. No.: US 2005/0107523 A1
(43) Pub. Date: May 19, 2005

(54) Emulsifier-free oil-in-water emulsions of organopolysiloxanes and the use thereof in technical applications

(76) Inventors: Michael Gippert, Essen (DE); Ralf Schnelle, Essen (DE); Stefan Silber, Krefeld (DE); Roland Sucker, Werne (DE); Dirk Wolfgram, Bochum (DE)

Correspondence Address: William F. Lawrence, Esq.;c/o FROMMER LAWRENCE & HAUG LLP, 745 Fifth Avenue, New York, NY, 10151, US

(21) Appl. No.: 10/989,996

(22) Filed: Nov. 16, 2004

(30) Foreign Application Priority Data
Nov. 18, 2003 (DE) 103 53 856.9

(51) Int. Cl. C08L 83/00

(52) U.S. Cl. 524/588

(57) ABSTRACT

The invention relates to emulsifier-free oil-in-water emulsions of organopolysiloxanes and the use thereof in technical applications.

### RELATED APPLICATIONS

This application claims priority to German Application Ser. No. 103 53 856.9, filed Nov. 18, 2003, herein incorporated by reference.

### BACKGROUND OF THE INVENTION

### FIELD OF THE INVENTION

The invention relates to emulsifier-free oil-in-water emulsions of organopolysiloxanes and the use thereof in technical applications.

Emulsions are mixtures of at least two liquids which are substantially immiscible with/insoluble in one another and which are emulsified mechanically with the use of, for example, high-speed stirrers, mixing pumps or ultrasonic generators.

Since, owing to their pronounced hydrophobic properties, silicones can be mechanically emulsified in water only with difficulty, the concomitant use of surfactant, hydrophilic emulsifiers which reduce the surface tension existing between the phases and permit the homogenization thereof has been indispensable to date for the preparation of stable emulsions.

In addition, organic and/or inorganic coemulsifiers and further auxiliaries are also often required for the preparation and stabilization thereof, such as, for example, solubilizers, thickeners or protective colloids.

These emulsions are a component of a multiplicity of formulations in a very wide range of applications, such as in cosmetic skin/hair cleansing or care compositions, in household and in industrial cleaning agents, in softener formulations and mold release agents and for defoaming, in particular of aqueous systems.

As an undesired accompanying phenomenon, however, the surface-active substances contained in them stabilize the incorporated air in the form of foam.

Foam frequently forms in the preparation and/or in the application of aqueous systems. Foam crowns which accumulate during stirring and dispersing processes or in the containers during the filling process prolong the production times or reduce the effective volume of the plant.

In the application of coating systems, such as, for example, varnishes, emulsion paints and printing inks, the foam is troublesome since it leads to undesired surface defects after drying of the film. During printing, it causes ink troughs to overflow and prevents good ink transfer.

This problem is counteracted by adding antifoams or deaerators, which on the one hand are intended to prevent foam formation and on the other hand are intended to destroy existing foam, and the adverse effects on other parameters should be as small as possible.

According to conventional opinion, a distinction is made between antifoams and deaerators.

In aqueous systems, antifoams lead to destruction of the macrofoam at the surface and to avoidance of large air inclusions.

During the application, deaerators remove the air dispersed in finely divided form as rapidly as possible from the depth of the formulation, such as, for example, the coating film. In practice, this clear differentiation is generally not possible. Thus, antifoams are to a certain extent also effective against microfoam.

Antifoams must have a controlled incompatibility with the system, excessively high compatibility generally being adverse for the defoaming, and it often being possible for excessively low compatibility to lead to defects, in particular in inks, varnishes or coatings.

In order to achieve a correspondingly optimum effect, the antifoam must be present in the form of very fine stable droplets. Aqueous antifoam emulsions are emulsions of the O/W type whose dispersed phases, which consist of the antifoam active substance, comprise droplets having a mean particle diameter between 1 and 10 μm.

Antifoam active substances may be oils of various types, e.g. vegetable and animal oils, liquid paraffins and mineral oils. These are increasingly being supplemented or replaced by hydrophobic, optionally organically modified polysiloxanes and polyoxyalkylene-polysiloxane block copolymers and blends thereof with one another and/or among one another. These are very active substances which exhibit their strengths in particular in the modern water-based varnish and printing ink systems. In addition to the advantage of not reducing the gloss, these antifoams are distinguished by good compatibility.

There is a multiplicity of publications and patents in which the mode of action of the polysiloxanes is described and in which information is given regarding the choice of the suitable siloxanes and their formulation forms.

As advantageous as these known antifoams may be in use, they all still have the disadvantage that surfactant, hydrophilic, organic emulsifiers have to be concomitantly used for the preparation of suitable emulsions and they are therefore in need of improvement with regard to foam prevention or foam elimination in aqueous systems and the avoidance of the disadvantages during the application.

The preparation of the stable antifoam emulsions should be possible using simple stirring tools without a complicated stirring technique being required or special precautions having to be taken. The stability of the emulsions has to meet high requirements. The emulsions should in particular have high stability under thermal and mechanical stress.

### OBJECTS OF THE INVENTION

It is an object of the present invention to solve this technical problem. This and other objects are apparent from the following description of the invention.

### DESCRIPTION OF THE INVENTION

The present invention therefore relates to emulsifier-free oil-in-water emulsions based on organofunctionally modified polysiloxanes, comprising at least two of the components A) to D)
A) of the general formula (I) 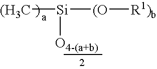
   in which
   R in the average molecule may be identical or different and preferably is an alkyl radical having 1 to 4 carbon atoms,
   a has an average numerical value of from 1 to 1.95 and
   b has an average numerical value of from 0.05 to 1, preferably from 0.05 to 0.35, the average molar masses being between about 700 g/mol and about 8500 g/mol, preferably between 1250 g/mol and 4500 g/mol;
B) of the general formula (II) 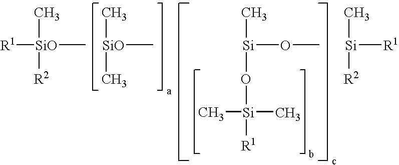
   in which
   R¹ in the average molecule may be identical or different and is a hydrocarbon radical optionally containing double bonds and preferably having 1 to 8 carbon atoms or the radical —Z—(CₙH₂ₙ—O—)ₘR′, with a functionalization density (FD)≦500, preferably ≦100, in particular ≦50, and in which
   R′ is a hydrogen radical or an alkyl radical preferably having 1 to 8 carbon atoms,
   R² is phenyl, ethyl, methyl, hydroxyl or amino, with at least 90% methyl,
   Z is a divalent radical of the formula O—, —NH—, —NR³— with R³═C₁₋₄-alkyl radical, or —S—,
   n has an average numerical value from greater than 2.7 to 4.0, preferably from 2.8 to 3.0,
   m has an average numerical value from 5 to 130, preferably from 6 to 50, in particular from 8 to 15,
   a has an average numerical value from 4 to 1500, preferably from 5 to 500, in particular from 10 to 80,
   b has an average numerical value from 0 to 100, preferably from 0 to 10, in particular from 0 to 1,
   c has an average numerical value from 0 to 100, preferably from 0 to 10, in particular from 0 to 1;
C) of the general formula (III) 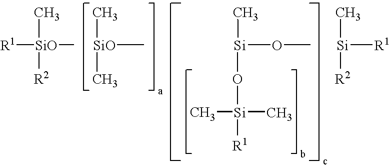
   in which
   R¹ in the average molecule may be identical or different and is an alkyl radical preferably having 1 to 8 carbon atoms or the radical —Z—(CₙH₂ₙ—O—)ₘR′, having a functionalization density FD of from about 15 to about 50, preferably from 20 to 40, in particular from 25 to 35, and in which
   R′ is a hydrogen radical or an alkyl radical preferably having 1 to 8 carbon atoms or acyl,
   R² is phenyl, ethyl, methyl, hydroxyl or amino, with at least 90% methyl,
   Z is a divalent radical of the formula —(CH₂)ₚ—O— or —CH₂—CH(CH₃)—CH₂—O—where p=2, 3 or 4,
   n has an average numerical value of from 2.6 to 4.0, preferably from 2.8 to 3.0,
   m has an average numerical value of from 5 to 130, preferably from 6 to 50, in particular from 8 to 15,
   a has an average numerical value of from 4 to 1500, preferably from 10 to 1000, in particular from 40 to 100,
   b has an average numerical value of from 0 to 100, preferably from 0 to 10, in particular 0,
   c has an average numerical value of from 1 to 100;
D) of the general formula (IV) 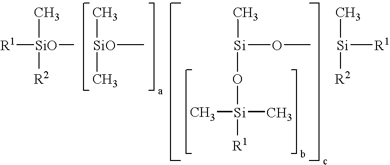
   in which
   R¹ in the average molecule may be identical or different and is an alkyl radical preferably having 1 to 8 carbon atoms or the radical —Z—(CₙH₂ₙ—O—)ₘR′ having a functionalization density FD of from about 3 to <15, preferably from 4 to <15, in particular from 7 to <15, and in which
   R′ is a hydrogen radical or an alkyl radical having 1 to 8 carbon atoms or acyl,
   R² is phenyl, ethyl, methyl, hydroxyl or amino, with at least 90% methyl,
   Z is a divalent radical of the formula —(CH₂)ₚ—O— or —CH₂—CH(CH₃)—CH₂—O— where p=2, 3 or 4,
   n has an average numerical value of from 2.7 to 4.0, preferably from 2.8 to 3.0,
   m has an average numerical value of from 5 to 130, preferably from 20 to 80, in particular from 25 to 45,
   a has an average numerical value of from 4 to 1500, preferably from 10 to 1000, in particular from 40 to 100,
   b has an average numerical value of from 0 to 50, preferably from 0 to 10, in particular 0,
   c has an average numerical value of from 1 to 100, preferably from 2 to 30, in particular from 4 to 12.

The abovementioned components may optionally contain hydrophobic solids. Further customary auxiliaries and additives, such as thickeners, protective colloids and/or preservatives, may be used for the formulation.

The functionalization density FD of organo-modified polysiloxanes is calculated from the ratio of the total number of unsubstituted silicone units to the total number of substituted silicone units. As an example here:
MDₙD^{R}ₘM
M—M units OSi(CH₃)₃
D—unsubstituted D units OSi(CH₃)₂ (n number)
D^{R}—substituted D units OSiRCH₃ (m number)
   FD=n+2/m

It was surprising that the combinations according to the invention spontaneously emulsify in water and remain stable even at elevated temperature and/or under mechanical stress and during storage.

According to the invention, at least two, preferably three, components, but in particular all 4 components A) to D), are used simultaneously since, on the one hand, this combination has an advantageous influence on the preparation and stability of the emulsion and, on the other hand, the effect strived for, in particular the defoaming and/or deaerating effect, and the stability in aqueous emulsions and/or dispersions of the various technical applications, such as, for example, of varnishes, paints, coatings, parting compositions, preservatives for structures, cleaning agents or cosmetic formulations, can be considerably improved.

Antifoam emulsions to be prepared according to the invention can be used in a manner known per se, inter alia for the defoaming of surfactant solutions, surfactant concentrates, latex dispersions (for example for paper coatings, adhesives, emulsion paints), varnishes, water-based printing inks and further aqueous binders.

The following process is used for the preparation:
a) From about 95 to about 40 parts by weight of water are initially introduced into a stirred vessel and optionally treated with thickeners, protective colloids and/or preservatives.
b) From about 5 to about 60% by weight of a mixture which may contain the compounds of the formulae A) to D), but contains at least two thereof, the mixing ratio of all components A) to D) contained in the mixture being such that at least 5 parts by weight of each individual component are contained in the mixture, the sum of the parts by weight used being 100, are added to this prepared mixture. Up to about 15 parts by weight of corresponding fillers can optionally be added to this mixture.
c) After addition of the abovementioned mixture, homogenization is effected by suitable technical means.

Exemplary thickeners and protective colloids are polymers of different groups, such as cellulose derivatives, polyvinyl alcohols, polyacrylates, polyurethanes, polyureas and polyetherpolyols. Examples of hydrophobic inorganic solids are silica, alumina or alkaline earth metal carbonates which have optionally been rendered hydrophobic or similar customary finely divided solids known from the prior art. Organic hydrophobic substances for this purpose are known alkaline earth metal salts are of long-chain fatty acids having 12 to 22 carbon atoms, the amides of such fatty acids, and polyureas and waxes.

### EXAMPLES

The invention is exemplified by the following non-limiting examples;

### General Example 1

Preparation of an Aqueous Emulsion

From 95 to 40 parts by weight of water are initially introduced into a stirred vessel and from 0.05 to 5 parts by weight of a thickener are added. The pH of this mixture is then adjusted to pH 8 with a base.

From 5 to 60% by weight of a mixture which may contain all compounds of the formulae A to D, but contains at least two thereof, the mixing ratio of all components A to D contained in the mixture being such that at least 5 parts by weight of each individual component are contained in the mixture, the sum of the parts by weight used being 100, are added to this prepared mixture. Up to 15 parts by weight of corresponding fillers can optionally be added to this mixture.

After addition of the abovementioned mixture, homogenization is effected using a suitable stirring element.

### Example 2

7.5 parts by weight of a finely dispersed silica were added to 92.5 parts by weight of a siloxane of the formula A) (a to 1.92; b=0.13). The mixture thus obtained was heated to 100° C. for 3 h.

10.0 parts by weight of this heated product were added, together with 10 parts by weight of a siloxane of the formula B (c=0, a=16, R1=—Z—(CₙH₂ₙ—O—)ₘR′ where R′=C₃ and n=2.8, m=12, Z=O), to 80 parts by weight of a mixture comprising 95 parts by weight of water and 2.5 parts by weight of a 30% strength emulsion of a thickener based on a polyacrylate (commercially available, for example, under the name Viscalex® HV 30), which mixture was adjusted to a pH of 8 with 2.5 parts by weight of a 10% strength NaOH, and were stirred with one another with low shear forces.

### Example 3

7.5 parts by weight of a finely disperse silica were added to 92.5 parts by weight of a siloxane of the formula A) (a to 1.93; b=0.15). The mixture thus obtained was heated to 100° C. for 3 h.

10.0 parts by weight of this heated product were added, together with 10 parts by weight of a siloxane of the formula B (c=0, a=16, R¹=—Z—(CₙH₂ₙ—O—)ₘR where R′=C₃ and n=2.8, m=12, Z=O), to 80 parts by weight of a mixture comprising 95 parts by weight of water and 2.5 parts by weight of a 30% strength emulsion of a thickener based on a polyacrylate (commercially available, for example, under the name Viscalex® HV 30), which mixture was adjusted to a pH of 8 with 2.5 parts by weight of a 10% strength NaOH, and were stirred with one another with low shear forces.

### Comparative Examples

### Example 4

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

20.0 parts by weight of the heated mixture from example 2 were added to this prepared mixture and stirred with a turbine at a speed of 1000 rpm for 5 min.

It was not possible to obtain an emulsion.

### Example 5

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

10.0 parts by weight of the heated mixture from example 3 were added to this prepared mixture and stirred with a turbine at a speed of 1000 rpm for 2 min. Thereafter, 10.0 parts by weight of a siloxane of the formula C (c=0.5, b=0, a=65, R¹=—(CH₂)ₚ—O—(CₙH₂ₙ—O—)ₘR′ where R′=H and n=2.8, m=12, p=3) were added to this emulsion and once again stirred with a turbine at a speed of 1000 rpm for 3 min.

### Example 6

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

10.0 parts by weight of a siloxane of the formula B (c=0, a=16, R¹=—Z—(CₙH₂ₙ—O—)ₘR′ where R′=C₃ and n=2.8, m=12, Z=O) were added, together with 10.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3), to this prepared mixture and stirred with an MIG stirrer (multistage impulse countercurrent agitator) at 500 rpm for 10 min.

### Example 7

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

14.3 parts by weight of a siloxane of the formula B (c=0, a=16, R¹=—Z—(CₙH₂ₙ—O—)ₘR′ where R′=C₃ and n=2.8, m=12, Z=0) were added, together with 5.7 parts by weight of a siloxane of the formula D) (c=8.5, b=0, a=70, R′=—(CH₂)ₚ—O—(CₙH₂ₙ—O—)ₘR′ where R′=H and n=2.9, m=33, p=3), to this prepared mixture and stirred with an MIG stirrer (multistage impulse countercurrent agitator) at 500 rpm for 10 min.

### Example 8

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

10.0 parts by weight of the heated mixture from example 2 were added, together with 7.5 parts by weight of a siloxane of the formula B) (c=0, a=16, R¹=—Z—(Cₙ H₂ₙ—O—)ₘR′ where R′=C₃ and n=2.8, m=12, Z=O) and 2.5 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3), to this prepared mixture and stirred with an MIG stirrer (multiphase impulse countercurrent agitator) at 500 rpm for 10 min.

### Example 9

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

10.0 parts by weight of a siloxane of the formula B (c=0, a=16, R¹=—Z—(CₙH₂ₙ—O—)ₘR′ where R′=C₃ and n=2.8, m=12, Z=O) were added, together with 8.0 parts by weight of a siloxane of the formula A) (c=3, a+b=28 and R¹=OC₂H₅) and 2.0 parts by weight of a siloxane of the formula D) (c=8.5, b=0, a=70, R¹=—(CH₂)ₚ—O—(CₙH₂ₙ—O—)ₘR′ where R′=H and n=2.9, m=33, p=3) to this prepared mixture and stirred with one another with low shear forces.

### Example 10

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH.

5.0 parts by weight of a siloxane of the formula B (c=0, a=16, R¹=—Z—(CₙH₂ₙ—O—)ₘR′ where R′=C₃ and n=2.8, m=12, Z=O) were added, together with 5.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) and 10.0 parts by weight of a siloxane of the formula D) (c=8.5, b=0, a=70, R¹=—(CH₂)ₚ—O—(CₙH₂ₙO—)ₘR′ where R′=H and n=2.9, m=33, p=3) to this prepared mixture and stirred with an MIG stirrer (multiphase impulse countercurrent agitator) at 500 rpm for 10 min.

### Example 11

76 parts by weight of water were initially introduced into a stirred vessel, and 2.0 parts by weight of a 30% strength emulsion of a thickener based on a polyacrylate (commercially available, for example, under the name Viscalex®D HV 30) were added. The pH of this mixture was then adjusted to 8 with 2.0 parts by weight of a 10% strength NaOH.

8.0 parts by weight of the heated mixture from example 2 and 5.0 parts by weight of a siloxane of the formula B) (c=0, a=16, R¹=—Z—(CₙH₂ₙ—O—)ₘR′ where R′=C₃ and n=2.8, m=12; Z=O) and 2.0 parts by weight of a siloxane of the formula D) (c=8.5, b=0, a=70, R¹=—(CH₂)ₚ—O—(CₙH₂ₙ—O—)ₘR where R′=H and n=2.9, m=33, p=3) were added together to this prepared mixture and stirred with an MIG stirrer (multiphase impulse countercurrent agitator) at 500 rpm for 10 min. 5.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) were then added in portions to this emulsion with stirring with an MIG stirrer at 500 rpm, and finally stirring was effected for a further 2 min.

### Example 12

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 14.3 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) were added, together with 5.7 parts by weight of a siloxane of the formula D) (c=8.5, b=0, a=70, R¹=—(CH₂)ₚ—O—(CₙH₂ₙ—O—)ₘR′ where R′=H and n=2.9, m=33, p=3), to this prepared mixture and stirred with an MIG stirrer (multiphase impulse countercurrent agitator) at 500 rpm for 10 min.

### Example 13

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 10.0 parts by weight of the heated mixture from example 3 and 5.0 parts by weight of a siloxane of the formula B) (c=0, a=16, R¹=—Z—(CₙH₂ₙ—O—)ₘR′ where R′=C₃ and n=2.8, m=12; Z=O) and 1.0 part by weight of a siloxane of the formula D) (c=8.5, b=0, a=70, R¹=—(CH₂)ₚ—O—(CₙH₂ₙ—O—)ₘR′ where R′=H and n=2.9, m=33, p=3) were added together to this prepared mixture and stirred with an MIG stirrer (multiphase impulse countercurrent agitator) at 500 rpm for 10 min. 4.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) were then added dropwise continuously in the course of 5 min to this emulsion with stirring with an MIG stirrer at 500 rpm, and finally stirring was effected for a further 2 min.

### Example 14

57 parts by weight of water were initially introduced into a stirred vessel, and 1.5 parts by weight of a 30% strength emulsion of a thickener based on a polyacrylate (commercially available, for example, under the name Viscalex® HV 30) were added. The pH of this mixture was then adjusted to 8 with 1.5 parts by weight of a 10% strength NaOH. 16.0 parts by weight of the heated mixture from example 2 and 10.0 parts by weight of a siloxane of the formula B) (c=0, a=16, R¹=—Z—(CₙH₂ₙ—O—)ₘR′ where R′=C₃ and n=2.8, m=12; Z=0) and 4.0 parts by weight of a siloxane of the formula D) (c=8.5, b=0, a=70, R¹=—(CH₂)ₚ—O—(CₙH₂ₙ—O—)ₘR′ where R′=H and n=2.9, m=33, p=3) were added together to this prepared mixture and stirred with an MIG stirrer (multiphase impulse countercurrent agitator) at 500 rpm for 10 min. 10.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) were then added to this emulsion with stirring with an MIG stirrer at 500 rpm and finally stirring was effected for a further 2 min.

### Example 15

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 8.0 parts by weight of the heated mixture from example 2 and 5.0 parts by weight of a siloxane of the formula B) (c=0, a=16, R¹=—Z—(CₙH₂ₙ—O—)ₘR′ where R′=C₃ and n=2.8, m=12; Z=0) and 2.0 parts by weight of a siloxane of the formula D) (c=8.5, b=0, a=70, R¹=—(CH₂)ₚ—O—(CₙH₂ₙ—O—)ₘR′ where R′=H and n=2.9, m=33, p=3) were added together to this prepared mixture and stirred with an MIG stirrer (multiphase impulse countercurrent agitator) at 500 rpm for 10 min. 5.0 parts by weight of a siloxane of the formula C) (c=0.5, b=0, a=65, R¹=—(CH₂)ₚ—O—(CₙH₂ₙ—O—)ₙR′ where R′=H and n=2.8, m=12, p=3) were then added to this emulsion with stirring with an MIG stirrer at 500 rpm and finally stirring was effected for a further 2 min.

### Comparative Example 16

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 20.0 parts by weight of a siloxane of the formula B (c=0, a=16, R¹=—Z—(CₙH₂ₙO—)ₙR′ where R′=C₃ and n=2.8, m=12; Z=O) were added to this prepared mixture and stirred with an MIG stirrer (multiphase impulse countercurrent agitator) at 500 rpm for 10 min. It was possible to obtain an emulsion in this way, but the emulsion thus obtained no longer acts as an antifoam.

### Comparative Example 17

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 20.0 parts by weight of a siloxane of the formula C) (c=0.5, b=0, a=65, R¹=—(CH₂)ₚ—O—(CₙH₂ₙ—O—)ₘR′ where R′=H and n=2.8, m=12, p=3) were added to this prepared mixture and stirred with an MIG stirrer (multiphase impulse countercurrent agitator) at 500 rpm for 10 min. The O/W emulsion initially obtained inverts in a very short time and, as a W/O emulsion, can then no longer easily be diluted with water.

### Comparative Example 18

76 parts by weight of water were initially introduced into a stirred vessel, and 2.0 parts by weight of a 30% strength emulsion of a thickener based on a polyacrylate (commercially available, for example, under the name Viscalex® HV 30) were added. The pH of this mixture was then adjusted to 8 with 2.0 parts by weight of a 10% strength NaOH. 20.0 parts by weight of a siloxane of the formula D) (c=8.5, b=0, a=70, R¹=—(CH₂)ₚ—O—(CₙH₂ₙ—O—)ₘR′ where R′=H and n=2.8, m=33, p=3) were added to this prepared mixture and stirred with an MIG stirrer (multiphase impulse countercurrent agitator) at 500 rpm for 10 min.

It is possible to obtain an emulsion in this way, but the emulsion thus obtained no longer acts as an antifoam.

Use in Aqueous Formulations:

50.0 g of a flexographic printing ink which was adjusted beforehand to a viscosity of 23″ (″=seconds efflux time) on measurement with the DIN 4 efflux cup are weighed, accurately to 0.1 g, into a polyethylene cup having a nominal volume of 180 ml. 0.25% (0.125 g) of antifoam emulsion is weighed into this ink.

The antifoam emulsion is incorporated on a Dispermat with a dissolver disk (d=3 cm) for 120″ at a speed of 1500 rpm.

The flexographic printing ink to which antifoam emulsion has been added is stored for 1 day.

A small amount (about 1 ml) of this ink is applied to a Hostaphan film with the aid of a 12 μm spiral applicator. The ink to which antifoam has been added and which remains in the PE cup is then stirred for 60″ at a speed of 3000 rpm with a dissolver disk (d=3 cm) on the Dispermat. After the time has elapsed, 45 g of the foamed ink are rapidly poured into a tared and graduated measuring cylinder having a nominal volume of 100 ml for determining the volume, and the total volume is read. The lower the volume read, the better is the antifoam performance.

42.0 g of this foamed ink are again weighed, accurately to 0.1 g, into a polyethylene cup having a nominal volume of 180 ml, 8.0 g of water are added and stirring is again effected for 60″ at a speed of 3000 rpm with a dissolver disk (d=3 cm) on the Dispermat. After the time has expired, 45 g of the ink which has been foamed again are rapidly poured into a tared 100 ml measuring cylinder for determining the volume, and the total volume is read again.

After freedom from foam, a small amount (about 1 ml) of the now dilute flexographic printing ink is applied to a Hostaphan film with the aid of a 12 μm spiral applicator.

The compatibility of the antifoam emulsion is determined purely visually, via the amount and/or type of surface defects, on the basis of the two ink coats after drying thereof.

Results:

| Viscosity of the ink: | | DIN4:23″ | | DIN4:15″ | |
|---|---|---|---|---|---|
| Antifoam. | Concentration used % | ml/45 g | Compatibility | ml/45 g | Compatibility |
| Example 7 | 0.25 | 65 | 1.25 | 74 | 2 |
| Example 8 | 0.25 | 49 | 3 | 60 | 2.5 |
| Example 9 | 0.25 | 49 | 3 | 60 | 3 |
| Example 10 | 0.25 | 53 | 2 | 48 | 2.75 |
| Example 11 | 0.25 | 48 | 3 | 50 | 2.5 |
| Example 12 | 0.25 | 60 | 1.25 | 63 | 2 |
| Example 15 | 0.25 | 50 | 3 | 59 | 2 |
| *Commercial E 1 | 0.25 | 60 | 3 | 73 | 3 |
| **Commercial E 2 | 0.25 | 57 | 2.5 | 68 | 2.5 |
| None | — | 84 | 1 | 94 | 1 |

*/**Based on organopolysiloxane and comprising a hydrophilic surfactant emulsifier

Assessment of the compatibility:
1—very compatible, 2—compatible, 3—incompatible, 4—very incompatible

For the determination of the emulsion stability, 1.0 ml of the antifoam emulsion is introduced into a graduated measuring cylinder filled with 99.0 ml of distilled water and shaken gently five times. 10.0 ml of this dilution are again diluted with 90 ml of distilled water in the graduated measuring cylinder and shaken gently five times. The time up to any phase separation is then measured and noted.

Results:

| Antifoam emulsion | Time |
|---|---|
| Example 2 | >400 min |
| Example 3 | >400 min |
| Example 5 | >400 min |
| Example 6 | >400 min |
| Example 7 | >400 min |
| Example 9 | >400 min |
| Example 10 | >400 min |
| Example 11 | >400 min |
| Example 13 | >400 min |
| Example 14 | >400 min |
| *Commercial antifoam 1 | 120 min |
| **Commercial antifoam 2 | 360 min |

*/**Based on organopolysiloxane and comprising a hydrophilic surfactant emulsifier

The above description is intended to be illustrative and not limiting. Various changes or modifications in the embodiments may occur to those skilled in the art. These can be made without departing from the scope or spirit of the invention.

1. An emulsifier-free oil-in-water emulsion based on organofunctionally modified polysiloxanes, comprising at least two of the components A) to D):
A) of the general formula (I) 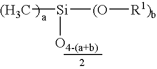
in which
R¹ in the average molecule may be identical or different and is an alkyl group,
a has an average numerical value of from 1 to 1.95 and
b has an average numerical value of from 0.05 to 1;
B) of the general formula (II) 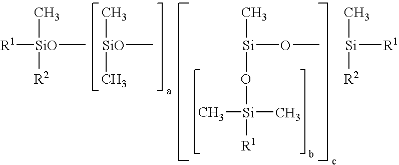
in which
R¹ in the average molecule may be identical or different and is a hydrocarbon radical optionally containing double bonds or the radical —Z—(CₙH₂ₙ—O—)ₘR′, having a functionalization density (FD)≦500, and in which
R′ is a hydrogen radical or an alkyl radical,
R² is phenyl, ethyl, methyl, hydroxyl or amino, with at least 90% methyl,
Z is a divalent radical of the formula —O—, —NH—, —NR³— with R³═C₁₋₄-alkyl radical, or —S—,
n has an average numerical value from greater than 2.7 to 4.0,
m has an average numerical value from 5 to 130,
a has an average numerical value from 4 to 1500,
b has an average numerical value from 0 to 100,
c has an average numerical value from 0 to 100;
C) of the general formula (III) 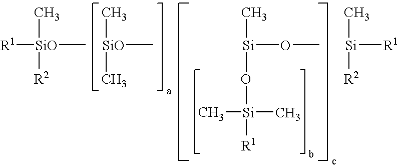
in which
R¹ in the average molecule may be identical or different and is an alkyl radical or the radical —Z—(CₙH₂ₙ—O—)ₘR′, having a functionalization density FD of from about 15 to about 50, and in which
R′ is a hydrogen radical or an alkyl radical or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O— with p=2, 3 or 4,
n has an average numerical value of from 2.6 to 4,
m has an average numerical value from 5 to 130,
a has an average numerical value from 4 to 1500,
b has an average numerical value from 0 to 100,
c has an average numerical value from 0 to 100;
D) of the general formula (IV) 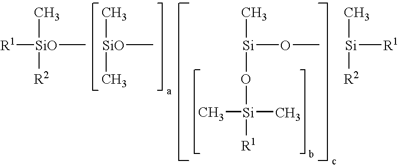
in which
R¹ in the average molecule may be identical or different and is an alkyl radical or the radical —Z—(CₙH₂ₙ—O—)ₘR′, having a functionalization density FD of from about 3 to <15, and in which
R′ is a hydrogen radical or an alkyl radical or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O—where p=2, 3 or 4,
n has an average numerical value from 2.7 to 4.0,
m has an average numerical value from 5 to 130,
a has an average numerical value from 4 to 1500,
b has an average numerical value from 0 to 50,
c has an average numerical value from 1 to 100, and optionally further auxiliaries and additives.

2. The emulsifier-free oil-in-water emulsion as claimed in claim 1, comprising at least two of the components A) to D):
A) of the general formula (I) 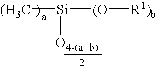
in which
R¹ in the average molecule may be identical or different and is an alkyl radical having 1 to 4 carbon atoms,
a has an average numerical value of from 1 to 1.95 and
b has an average numerical value of from 0.05 to 1;
B) of the general formula (II) 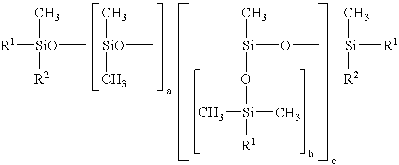
in which
R¹ in the average molecule may be identical or different and is a hydrocarbon radical optionally containing double bonds and having 1 to 8 carbon atoms or the radical —Z—(CₙH₂ₙ—O—)ₘR′, having a functionalization density (FD)≦500, and in which
R′ is a hydrogen radical or an alkyl racial having 1 to 8 carbon atoms,
R² is phenyl, ethyl, methyl, hydroxyl or amino, with at least 90% methyl,
Z is a divalent radical of the formula —O—, —NH—, —NR³— with R³═C₁₋₄-alkyl radical, or —S—,
n has an average numerical value from greater than 2.7 to 4.0,
m has an average numerical value from 5 to 130,
a has an average numerical value from 4 to 1500,
b has an average numerical value from 0 to 100,
c has an average numerical value from 0 to 100;
C) of the general formula (III) 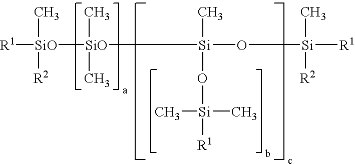
in which
R¹ in the average molecule may be identical or different and is an alkyl radical having 1 to 8 carbon atoms or the radical —Z—(CₙH₂ₙ—O—)ₘR′, having a functionalization density FD of from 15 to 50, and in which
R′ is a hydrogen radical or an alkyl radical having 1 to 8 carbon atoms or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O—with p=2, 3 or 4,
n has an average numerical value of from 2.6 to 4,
m has an average numerical value from 5 to 130,
a has an average numerical value from 4 to 1500,
b has an average numerical value from 0 to 100,
c has an average numerical value from 0 to 100;
D) of the general formula (IV) 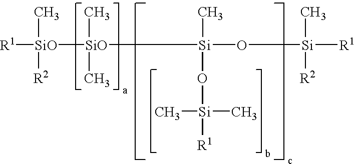
in which
R¹ in the average molecule may be identical or different and is an alkyl radical having 1 to 8 carbon atoms or the radical —Z—(CₙH₂ₙ—O—)ₘR′, having a functionalization density FD of from about 3 to <15, and in which
R′ is a hydrogen radical or an alkyl radical having 1 to 8 carbon atoms or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O—where p=2, 3 or 4,
n has an average numerical value from 2.7 to 4.0,
m has an average numerical value from 5 to 130,
a has an average numerical value from 4 to 1500,
b has an average numerical value from 0 to 50,
c has an average numerical value from 1 to 100,
and optionally further customary auxiliaries and additives.

3. The emulsifier-free oil-in-water emulsion as claimed in claim 1, wherein compounds of the general formula (I) in which
R¹ in the average molecule may be identical or different and is a an alkyl radical having 1 to 4 carbon atoms,
a has an average numerical value from 1 to 1.95 and
b has an average numerical value from 0.05 to 1, are concomitantly used as component A).

4. The emulsifier-free oil-in-water emulsion as claimed in claim 1, wherein compounds of the general formula (II) in which
R¹ in the average molecule may be identical or different and is a hydrocarbon radical optionally containing double bonds and having 1 to 8 carbon atoms or the radical —Z—(CₙH₂ₙ—O—)ₘR, having a functionalization density FD≦500, and in which
R′ is a hydrogen radical or an alkyl radical having 1 to 8 carbon atoms,
R² is phenyl, ethyl, methyl, hydroxyl or amino, with at least 90% methyl,
Z is a divalent radical of the formula —O—, —NH—, —NR³— with R³═C₁₋₄-alkyl radical, or —S—,
n has an average numerical value from 2.7 to 4.0,
m has an average numerical value from 5 to 130,
a has an average numerical value from 4 to 1500,
b has an average numerical value from 0 to 100,
c has an average numerical value from 0 to 100, are concomitantly used as component B).

5. The emulsifier-free oil-in-water emulsion as claimed in claim 1, wherein compounds of the general formula (III) in which
R¹ in the average molecule may be identical or different and is an alkyl radical having 1 to 8 carbon atoms or the radical —Z—(CₙH₂ₙ—O—)ₘR′, having a functionalization density FD of from 15 to 50, and in which
R′ is a hydrogen radical or an alkyl radical having 1 to 8 carbon atoms or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O— with p=2, 3 or 4,
n has an average numerical value from 2.6 to 4.0,
m has an average numerical value from 5 to 130,
a has an average numerical value from 4 to 1500,
b has an average numerical value from 0 to 100,
c has an average numerical value from 0 to 100, are concomitantly used as component C).

6. The emulsifier-free oil-in-water emulsion as claimed in claim 1, wherein compounds of the general formula (IV) in which
R¹ in the average molecule may be identical or different and is an alkyl radical having 1 to 8 carbon atoms or the radical —Z—(CₙH₂ₙ—O—)ₘR′, having a functionalization density FD of from 3 to <15, and in which
R′ is a hydrogen radical or an alkyl radical having 1 to 8 carbon atoms or acyl,
R² is phenyl, ethyl, methyl, hydroxyl or amino, with at least 90% methyl,
Z is a divalent radical of the formula —(CH₂)ₚ—O— or —CH₂—CH(CH₃)—CH₂—O— with p=2, 3 or 4,
n has an average numerical value from 2.7 to 4.0,
m has an average numerical value from 5 to 130,
a has an average numerical value from 4 to 1500,
b has an average numerical value from 0 to 50,
c has an average numerical value from 1 to 100, are concomitantly used as component D)

7. The emulsifier-free oil-in-water emulsion as claimed in claim 1, comprising
(I) from about 5 to about 60% by weight, based on the total formulation of at least two of the components A) to D), with the proviso that the proportion of the individual component is ≧5 parts by weight and the sum of the concomitantly used components is 100 parts by weight, and
(II) from 0 to about 15% by weight of customary auxiliaries and additives, and water to 100% by weight.

8. An emulsion paint or printing ink which comprises a pigment and the emulsifier-free oil-in-water emulsion as claimed in claim 1, excluding the presence of an emulsifier.

9. A method for defoaming a surfactant solution or a surfactant concentrate without the addition of an emulsifier which comprises adding the emulsifier-free oil-in-water emulsion according to claim 1.

10. A varnish which comprises an aqueous binder and the emulsifier-free oil-in-water emulsion according to claim 1, excluding the presence of an emulsifier.
